(19) United States
(12) Patent Application Publication
(10) Pub. No.: US 2007/0159073 A1
(43) Pub. Date: Jul. 12, 2007

(54) ELECTROLUMINESCENT DEVICE, DISPLAY APPARATUS, EXPOSURE APPARATUS, AND LIGHTING APPARATUS USING THE SAME

(75) Inventors: Kei SAKANOUE, Fukuoka (JP); Tetsuo TSUTSUI, Fukuoka (JP)

Correspondence Address: GREENBLUM & BERNSTEIN, P.L.C., 1950 ROLAND CLARKE PLACE, RESTON, VA, 20191, US

(73) Assignees: MATSUSHITA ELECTRIC INDUSTRIAL CO., LTD., Osaka (JP); KYUSHU UNIVERSITY, Fukuoka (JP)

(21) Appl. No.: 11/614,326

(22) Filed: Dec. 21, 2006

(30) Foreign Application Priority Data
Dec. 22, 2005 (JP) P2005-369103
Nov. 20, 2006 (JP) P2006-313120

(51) Int. Cl. H01J 1/62

(52) U.S. Cl. 313/504; 313/505; 313/506; 313/509

(57) ABSTRACT

To provide an electroluminescent device that is operable over a wide range from low luminance corresponding to a display apparatus, such as a display, to high luminance corresponding to, for example, a lighting apparatus or an exposure apparatus used for an image forming apparatus, is stably operable over the wide range of luminance, and has a satisfactory operating life characteristic even if the electroluminescent device has emitted light with high luminance, a display apparatus, an exposure apparatus, and a lighting apparatus using the same, an electroluminescent device includes a light emitting portion 5 having at least p-type semiconductor particles 10 and n-type semiconductor particles 11, and emission centers are provided in at least a type of semiconductor particles of the p-type semiconductor particles and the n-type semiconductor particles.

### BACKGROUND OF THE INVENTION

1. Field of the Invention

The present invention relates to an electroluminescent device, which is an electrical light emitting device and is used for a variety of light sources, a display apparatus, an exposure apparatus, and a lighting apparatus using the electroluminescent device as a light source.

2. Description of the Related Art

An electroluminescent device is a light emitting device using electroluminescence of a solid-state fluorescent material or the like. An electroluminescent device having a light emitting portion made of an inorganic material or an organic material is currently put into practical use, and application of the electroluminescent device to a flat display, a backlight of a liquid crystal display, or the like is being made. A structure of a known electroluminescent device is disclosed in Non-patent Document 1, Patent Document 1, and Patent Document 2

FIG. 8A is a cross-sectional view illustrating the structure of a known electroluminescent device, and FIG. 8B is an enlarged cross-sectional view illustrating the structure of a light emitting layer of a known electroluminescent device.

Hereinafter, the structure of an electroluminescent device 100 disclosed in Non-patent Document 1 will be described with reference to FIGS. 8A and 8B The electroluminescent device 100 shown in FIGS. 8A and 8B is classified as a so-called distributed direct-current-operation electroluminescent device.

As shown in FIG. 8A, the electroluminescent device 100 includes a glass substrate 101, an anode 102 formed of a transparent conductive material such as ITO (indium tin oxide) and a cathode 104 formed of a thin metal film, which are formed on the glass substrate 101, and a light emitting layer 103 interposed between the anode 102 and the cathode 104. The light emitting layer 103 is composed of ZnS (phosphor) particles 105 having particle diameters of about 0.5 to 1 μm and binder 106, as shown in the enlarged view of FIG. 8B. In the related art described above, in order to realize stable direct current driving, the ZnS (phosphor) particles 105 are processed in a solution containing Cu⁺ ions to thereby increase the electric conductivity and a necessary minimum amount of binder for forming a light emitting layer is used such that the packing density of the ZnS (phosphor) particles 105 is high enough to make the ZnS (phosphor) particles 105 being in contact with one another. When a DC voltage is applied to the anode 102 and the cathode 104 of the power line communication system 100 having the configuration described above, it is supposed that a luminance of about 1000 cd/m² can be obtained. However, in the electroluminescent device 100 disclosed in Nonpatent Document 1, the injection (more specifically, pair annihilation of charges in emission centers that are formed of the ZnS (phosphor) particles 105 and Cu, Cl, or Mn added in The ZnS (phosphor) particles 105) of charges with respect to the ZnS (phosphor) particles 105 are not sufficiently performed regardless of whether the diameters of the ZnS (phosphor) particles 105 are large or small or the packing density of the ZnS (phosphor) particles 105 is high or low. In addition, the luminous efficiency is about 0.2 to 0.3 lm/W, which is not high.

FIG. 9 is a view illustrating the structure of another known electroluminescent device.

Hereinafter, the structure of an electroluminescent device 110 disclosed in Patent Document 1 will be described with reference to FIG. 9.

As shown in FIG. 9, in the electroluminescent device 110, a light emitting layer is formed in a state in which semiconductor particles 112 made of CdSe are dispersed within a transparent electric conductor 111 made of, for example, ITO (indium tin oxide). In addition, the light emitting layer is interposed between electrodes 113 and 114. By applying a DC voltage of 10 V or less to the electrodes 113 and 114, it Is possible to cause the electroluminescent device 110 to emit light, with a driving voltage that is two orders of magnitude lower than that of an AC-driving-type inorganic electroluminescent device 110 in the related art. However, in the electroluminescent device 110 disclosed in Patent Document 1, it is difficult to uniformly disperse the semiconductor particles 112 within the transparent electric conductor 111 and a problem related to reproducibility, stability, and uniformity of light emission is to be solved.

Hereinbefore, an example of using an inorganic material for a light emitting layer of an electroluminescent device 110 has been described. However, various structures of electroluminescent devices using an organic material for light emitting layers thereof have been known. For example, as disclosed in Non-patent document 2, an electroluminescent device having a function-separation-type laminated structure has been proposed by C. W. Tang et el., Kodak corporation, 1987, an organic material used to form the light emitting layer being divided into two layers of a hole transport layer and a light emitting layer in the function-separation-type laminated structure. In this case, a high luminance of 1000 cd/m or more may be obtained with only a low voltage of 10 V or less. However, since the light emitting layer included in the electroluminescent device disclosed in Non-patent Document 2 uses an organic material, characteristics of the light emitting layer greatly deteriorate due to heat, moisture, or permeation of impurities through electrodes occurring as a result of driving. Thus, the light emitting layer is not satisfactory in terms of stability, luminous efficiency (luminance), an operating life, or the like.

Patent Document 1: JP-A-08-306485

Non-patent Document 1: Toshio Inoguchi, ‘Electroluminescent Display’, Sangyo Tosho Co., Ltd., pp. 13-15, Jul. 25, 1991

Non-patent Document 2: C. W. Tang, S. A. Vanslyke, ‘Appl. Phys. Lett.’ (U.S.A.), 51th edition, p. 913, 1987

In the technique related to an inorganic electroluminescent device disclosed in Non-patent document 1 or Patent Document 1, since it is not necessary to apply a high AC voltage when driving an electroluminescent device, a range of applications to which the electroluminescent device can be applied may increase. However, as described above, the problem related to luminous efficiency (luminance), operating life, reproducibility, stability, and uniformity of light emission should be solved. Further, as for the technique related to an organic electroluminescent device disclosed in Non-patent document 2, various improvements have been made after publication of Non-patent document 2. However, the problem in which the characteristics greatly deteriorate due to heat, moisture, or permeation of impurities through electrodes is not completely solved, and the luminous efficiency (luminance), the operating life, and the stability are not also satisfactory.

In addition, an application that uses an electroluminescent device as a light source includes a display apparatus such as a display, an image forming apparatus using an electrophotographic method, an exposure apparatus used to light a document in an image reading apparatus, and a lighting apparatus used for illumination, for example. Each of the apparatuses requires luminance and operating life depending on a corresponding application. For example, in a display apparatus, specifically, a monitor for a personal computer or a television, it is an important condition to maintain a luminance of about 500 cd/m² and a color balance of red, green, and blue even if 30000 hours passes.

On the other hand, in terms of luminance, an exposure apparatus is one of the devices that require most strict specifications. An electroluminescent device applied to a typical display apparatus can be sufficiently put into practical use if the luminance of the electroluminescent device is at most about 1000 cd/m². However, in an electroluminescent device applied to the exposure apparatus described above, the luminance of 20000 to 40000 cd/M² is required for red-colored light emission assuming that 600 dpi (dot per inch) and 40 ppm (pages per minute) are set as specifications of an image forming apparatus. Accordingly, a high voltage and a large current are required as a driving condition which is very tough. In order to allow an electroluminescent device to operate over a long period of time under the circumstances described above, it is necessary to greatly improve the luminous efficiency of the electroluminescent device.

If the luminous efficiency of an electroluminescent device is high, conditions of voltage and current required for driving are alleviated and heat generated in the electroluminescent device is reduced, which increases an operating life of the electroluminescent device, for example. As a result, it becomes possible to improve the reliability of the electroluminescent device over a long period of time. As described above, in the case of applying an electroluminescent device to a light source requiring a high luminance, such as an exposure apparatus, it is necessary to extremely increase the luminous efficiency of the electroluminescent device in order to improve the reliability.

### SUMMARY OF THE INVENTION

It is an object of the invention to provide an electroluminescent device that is operable over a wide range from low luminance corresponding to a display apparatus, such as a display, to high luminance corresponding to, for example, a lighting apparatus or an exposure apparatus used for an image forming apparatus, is stably operable over the wide range of luminance, and has a satisfactory operating life characteristic even if the electroluminescent device has emitted light with high luminance, a display apparatus, an exposure apparatus, and a lighting apparatus using the same.

The invention has been finalized in view of the drawbacks inherent in the related art. According to an aspect of the invention, an electroluminescent device includes a light emitting portion having at least p-type semiconductor particles and n-type semiconductor particles, and emission centers are provided in at least a type of semiconductor particles of the p-type semiconductor particles and the n-type semiconductor particles.

In the invention, the light emitting portion of the electroluminescent device has the p-type semiconductor particles and the n-type semiconductor particles and the emission centers are provided in at least a type of semiconductor particles of the p-type semiconductor particles and the n-type semiconductor particles. Accordingly, the light emitting portion can have a so-called bulk hetero-structure. That is, it is possible to configure the light emitting portion such that an extremely large amount of pn junctions exist in the light emitting portion. As a result, it becomes possible to realize an extremely high-level performance in both luminous efficiency (luminance) and operating life

By applying the electroluminescent device described above to a display apparatus, it is possible to provide a display apparatus having excellent color balance and no reduction in luminance over an extremely long period of time. Similarly, by applying the electroluminescent device to an exposure apparatus, it is possible to provide a reliable exposure apparatus that can stably operate over a long period of time (that is, when the exposure apparatus is mounted in an image forming apparatus using an electrophotographic method or the like, a performance for forming a latent image does not substantially deteriorate over a long period of time). Similarly, by applying the electroluminescent device to a lighting apparatus, it is possible to provide a reliable lighting apparatus whose power consumption is extremely low as compared with a light source for illumination in the related art.

### BRIEF DESCRIPTION OF THE DRAWINGS

FIG. 1A is a cross-sectional view illustrating the structure of an electroluminescent device according to a first embodiment of the invention.

FIG. 1B is an enlarged cross-sectional view illustrating the structure of a light emitting portion of the electroluminescent device according to the first embodiment of the invention.

FIG. 2A is a cross-sectional view illustrating the structure of an electroluminescent device according to a second embodiment of the invention.

FIG. 2B is an enlarged cross-sectional view illustrating the structure of a light emitting portion of the electroluminescent device according to the second embodiment of the invention.

FIG. 3 is a block diagram illustrating the entire configuration of a display apparatus according to a third embodiment of the invention.

FIG. 4 is a plan view illustrating display pixels included in the display apparatus according to the third embodiment of the invention.

FIG. 5 is a view illustrating the configuration of an exposure apparatus according to a fourth embodiment of the invention.

FIG. 6A is a top view illustrating a glass substrate of the exposure apparatus according to the fourth embodiment of the invention.

FIG. 6B is an enlarged view of the top view illustrating main parts of the glass substrate of the exposure apparatus according to the fourth embodiment of the invention.

FIG. 7 is a view illustrating a state in which a photoconductor is exposed by the exposure apparatus according to the fourth embodiment of the invention.

FIG. 8A is a cross-sectional view illustrating the structure of an electroluminescent device in the related art.

FIG. 8B is an enlarged cross-sectional view illustrating the structure of a light emitting layer of an electroluminescent device in the related art.

FIG. 9 is a view illustrating the structure of another electroluminescent device in the related art.

### DESCRIPTION OF THE PREFERRED EMBODIMENTS

An electroluminescent device according to an embodiment of the invention includes a light emitting portion having at least p-type semiconductor particles and n-type semiconductor particles, and emission centers are provided in at least a type of semiconductor particles of the p-type semiconductor particles and the n-type semiconductor particles. Since the light emitting portion of the electroluminescent device has the p-type semiconductor particles and the n-type semiconductor particles and the emission centers are provided in at least a type of semiconductor particles of the p-type semiconductor particles and the n-type semiconductor particles, the light emitting portion can have a so-called bulk hetero-structure. That is, it is possible to configure the light emitting portion such that an extremely large amount of pn junctions exist in the light emitting portion. As a result, it is possible to realize an electroluminescent device having extremely high luminous efficiency (luminance) and an extremely long operating life.

The luminescence in the electroluminescent device according to the embodiment of the invention is realized in a mechanism described above. Specifically, when a bias voltage is applied, holes and electrons are injected from an anode and a cathode to the p-type semiconductor particles and the n-type semiconductor particles, respectively. Pairs of holes and electrons formed in the vicinity of the p-type semiconductor particles or the n-type semiconductor particles having emission centers are trapped by ions, which form the emission centers, thereby causing the emission centers to be excited. Thus, light is emitted when element ions forming the emission centers return from an excitation state to a ground state.

Here, it may be possible to consider a known mechanism in which hot electrons are generated by applying a high AC voltage and thus the emission centers are excited to thereby emit light. However, in the device that emits light with a low voltage in the embodiment, the mechanism is not specifically known bat needs to be examined later. In the electroluminescent device according to the aspect of the invention, as described above, holes from the anode and electrons from the cathode are injected into the light emitting layer and the holes and electrons are recombined after a variety or excitation states, and thus light is emitted.

Accordingly, in the embodiment, the holes can be easily injected by providing an oxide layer having a high work function between the anode and the light emitting layer. In addition, the electrons can also be injected with a low voltage. This is because a transition metal oxide used here has an amorphous structure as a main structure and has many dangling bonds due to various crystal defects.

Further, in the embodiment, it is preferable to further include electrodes opposite to each other with the light emitting portion interposed therebetween. Preferably, the electrodes include a pair of anode and cathode and at least a charge injection portion is provided between the anode and the light emitting portion. Accordingly, since charges can be stably injected into the light emitting portion including the p-type semiconductor particles and the n-type semiconductor particles, it becomes possible to improve the luminous efficiency (luminance), to make the operating life long, and to improve stability of the electroluminescent device and uniformity of light emission.

Furthermore, in the embodiment, preferably, the anode is made of a substantially transparent conductive material. Thus, it becomes possible to make light emitted from the light emitting portion of the electroluminescent device with high efficiency.

Furthermore, in the embodiment, preferably, the cathode is made of at least a single-layered metal material. Thus, by causing light to be reflected from a metal material surface, it becomes possible to make the light emitted from the anode disposed opposite to the cathode with high efficiency.

Furthermore, in the embodiment, preferably, the charge injection portion is made of a transition metal oxide, more specifically, any one of molybdenum oxide, vanadium oxide, and tungsten oxide. Accordingly, since charges can be stably injected into the light emitting portion including the p-type semiconductor particles and the n-type semiconductor particles, it becomes possible to improve the luminous efficiency (luminance), to make the operating life long, and to improve the stability of the electroluminescent device and the uniformity of light emission. In addition, even with transition metal oxides other than above specially described transition metal oxides, the same effects as described above can be obtained.

Furthermore, in the embodiment, preferably, the charge injection portion is formed of a semiconductor. Accordingly, since charges can be stably injected into the light emitting portion including the p-type semiconductor particles and the n-type semiconductor particles, it becomes possible to improve the luminous efficiency (luminance), to make the operating life long, and to improve the stability of the electroluminescent device and the uniformity of light emission.

Furthermore, in the embodiment, it is preferable to further include electrodes opposite to each other with the light emitting portion interposed therebetween. Preferably, the electrodes include a pair of anode and cathode, and a DC voltage is applied between the anode and the cathode so as to drive the anode and the cathode. The electroluminescent device according to the embodiment of the invention has extremely high luminance efficiency. Accordingly, the electroluminescent device can be driven with DC power having a low voltage of 5 V, for example, which allows the electroluminescent device to be applied to various applications.

Furthermore, in the embodiment, it is preferable to further include electrodes opposite to each other with the light emitting portion interposed therebetween and a driving part that drives at least one of the electrodes. Preferably, the driving part is formed by using a thin film transistor. Since a thin film transistor is used as the driving part, a driving circuit can be obtained at a low cost.

Furthermore, in the embodiment, preferably, the p-type semiconductor particles and the n-type semiconductor particles are in contact with each other in the light emitting portion. Thus, since charges are injected into the emission centers with high efficiency, it becomes possible to realize an extremely high-level performance in both luminous efficiency (luminance) and operating life.

Furthermore, in the embodiment, preferably, the light emitting portion includes at least the p-type semiconductor particles, the n-type semiconductor particles, and a binder, and the light emitting portion is formed in a wet process. Due to the binder, the semiconductor particles can be easily handled. Accordingly, it is possible to apply a wet process, which is a so-called coating method, such as an inkjet method or a printing method As a result, a large number of electroluminescent devices can be manufactured at a low cost.

Furthermore, in the embodiment, preferably, the diameter of each of the p-type semiconductor particles and the n-type semiconductor particles is 1.0 μm or less. As described above, by using the particles having minute diameters, it is possible to increase the packing density of the p-type semiconductor particles and the n-type semiconductor particles in the light emitting portion. As a result, it becomes possible to realize an extremely high-level performance in the luminous efficiency (luminance).

Furthermore, in the embodiment, preferably, the light emitting port-on has a layered shape and the thickness of the layered light emitting portion is within a range of 0.1 μm to 10 μm. Accordingly, a sufficiently high electric potential can be applied to the layered light emitting portion. As a result, it becomes possible to drive the electroluminescent device with an extremely low driving voltage, for example, 5 V.

Further, in the embodiment, preferably, the p-type semiconductor particles are made of III-V group compound. III-V group compound includes GaAs, Alsb, GaP, InP, and the like and these can be easily converted into particles, the electroluminescent device can be manufactured in a simple process.

Further, in the embodiment, preferably, the n-type semiconductor particles are made of a material having the emission center. The n-type semiconductor particles are obtained by adding a predetermined activation element in any one of n-type-doped (hereinafter, referred to as ‘dope’) ZnS, ZnO, SrS, CaS, CdS, CaGa₂S₄, SrGa₂S₄, and BaAl₂S₄ so as to form the emission centers. Here, the added activation element is a so-called activator and includes a rare-earth element, such as Mn²⁺, Tm³⁺, Eu²⁺, Sm³⁺, or Tb³⁺, and compound activator such as Tb³⁺. Since these materials are very typical of luminescent materials of an inorganic electroluminescent device and can be easily converted into particles, the electroluminescent device can be manufactured in a simple process.

According to another aspect of the invention, there is provided a display apparatus having the plurality of electroluminescent devices described above disposed in a two-dimensional manner. Since the electroluminescent device according to the aspect of the invention has an extremely high-level performance in both luminous efficiency (luminance) and operating life, it is possible to provide a reliable display apparatus with no reduction in luminance over a long period of time.

Further, according to still another aspect of the invention, there is provided an exposure apparatus having the plurality of electroluminescent devices described above disposed in a one-dimensional or two-dimensional manner. Since the electroluminescent device according to the aspect of the invention has an extremely high-level performance in both luminous efficiency (luminance) and operating life, it is possible to provide a reliable exposure apparatus that can stably operate over a long period of time (that is, when the exposure apparatus is mounted in an image forming apparatus using an electrophotographic method or the like, a performance for forming a latent image does not substantially deteriorate over a long period of time).

Furthermore, according to still another aspect of the invention, there is provided a lighting apparatus having the single electroluminescent device or the plurality of electroluminescent devices described above disposed in a one-dimensional or two-dimensional manner. Since the electroluminescent device according to the aspect of the invention has an extremely high-level performance in both luminous efficiency (luminance) and operating life, it is possible to provide a reliable lighting apparatus whose power consumption is extremely low as compared with a light source for illumination in the related art.

In addition, according to still another aspect of the invention, an electroluminescent device includes a light emitting portion having at least a plurality of p-type semiconductor portions and a plurality of n-type semiconductor portions, and emission centers are provided in at least a type of semiconductor portions of the p-type semiconductor portions and the n-type semiconductor portions. Since the light emitting portion of the electroluminescent device has the plurality of p-type semiconductor particles and the plurality of n-type semiconductor particles and the emission centers are provided in at least a type of semiconductor particles of the p-type semiconductor particles and the n-type semiconductor particles, the light emitting portion can have a so-called bulk hetero-structure. That is, it is possible to configure the light emitting portion such that an extremely large amount of pn junctions exist in the light emitting portion. As a result, it becomes possible to realize an extremely high-level performance in both luminous efficiency (luminance) and operating life. The bulk hetero-structure referred in the embodiment includes a case in which p-type semiconductor portions and n-type semiconductor portions are in contact with each other in the same layer and a case in which a plurality of p-type semiconductor portions and a plurality of n-type semiconductor portions are repeatedly laminated in the form of layers. In this case, pn junctions are formed on interfaces between the layers.

### Embodiments

Hereinafter, the invention will be described in detail through preferred embodiments.

### First Embodiment

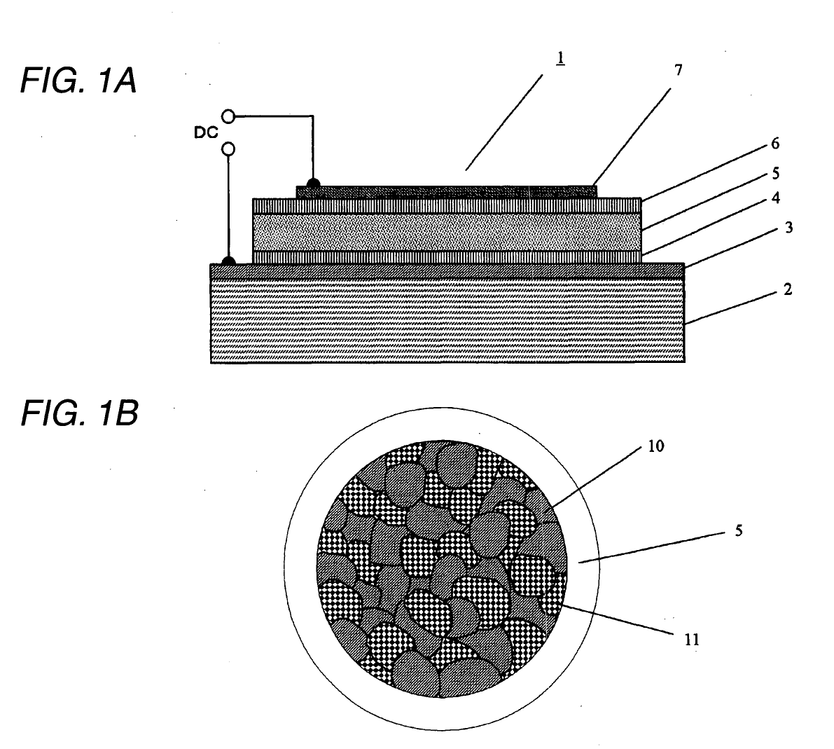

FIG. 1A is a cross-sectional view illustrating the structure of an electroluminescent device 1 according to a first embodiment of the invention, and FIG. 1B is an enlarged cross-sectional view illustrating the structure of a light emitting portion 5 of the electroluminescent device 1 according to the first embodiment of the invention.

The electroluminescent device 1 is characterized in that an anode 3, a charge injection portion 4, the light emitting portion 5, a charge injection portion 6, and a cathode 7 are sequentially laminated on a glass substrate 2 and the light emitting portion 5 includes a p-type semiconductor portion 10R and an n-type semiconductor portion 11R.

Hereinafter, it will be described about a process of manufacturing the electroluminescent device 1 according to the first embodiment of the invention with reference to FIGS. 1A and 1B.

First, the glass substrate 2 on which ITO (indium tin oxide) serving as a transparent conductive film to be the anode 3 is laminated was subjected to photolithographic and etching processes, thereby forming the anode 3 having a width of 2 mm in a stripe pattern.

In the first embodiment, the glass substrate 2 was used as a substrate. However, it is possible to use a plastic substrate other than the glass substrate 2 as long as the substrate is substantially transparent with respect to visible light. A material of the glass substrate 2 is not specifically selected. For example, a typical borosilicate glass or a quartz glass may be used. On the other hand, in the case of adopting the plastic substrate, it is desirable to provide, for example, a smooth layer made of an inorganic material on a surface in order to reduce moisture permeation and improve reliability.

The anode 3 is used to inject holes into the light emitting portion 5 to be described later and is substantially transparent. In addition, it is necessary to efficiently inject charges into the light emitting portion 5 or the charge injection portion 4 (will be described later). In general, a known transparent conductive film formed of, for example, ITO, tin oxide, or IZO is used as the anode 3.

Furthermore, in the first embodiment, the glass substrate 2 on which the ITO film is provided beforehand has been used to form the anode 3. However, it is possible to use the glass substrate 2, on which the tin oxide or IZO (indium zinc oxide) is provided, or other substrates that are substantially transparent. Preferably, a surface treatment may be performed on the ITO film by means of a processing apparatus using oxygen plasma.

Then, MoO₃ for the charge injection portion 4 was vapor-deposited on the anode 3 obtained as described above by using a resistance heating evaporation apparatus such that the charge injection portion 4 becomes a layer having a thickness of 50 nm. In the first embodiment, MoO₃ was used for the charge injection portion 4. However, the same effects can be obtained by the use of other materials, such as tungsten, vanadium, or tin as long as the materials are transition metal oxide.

Then, Mn serving as an emission center was added in ZnS that is a luminescent material and is activated by activator, such as CuO, in the ratio of Mn of 1×10⁻⁴ [g] to ZnS of 1 [g]. In addition, semiconductor particles (that is, n-type semiconductor particles having emission centers) obtained by grinding an n-type semiconductor as a result of doping of predetermined impurities (donors), such as Al or Cl, and semiconductor particles (p-type semiconductor particles) obtained by grinding GaAs as a p-type semiconductor obtained by doping predetermined impurities (acceptors) beforehand were set in an evaporation apparatus. Then, the light emitting portion 5 was formed by simultaneously vapor-depositing the n-type semiconductor particles and the p-type semiconductor particles at a speed of 1 Å per second such that the layer thickness is 0.1 μm. Here, ZnS and GaAs particles used for the vapor deposition were about 1 μm in mean particle diameter. After the vapor deposition, an annealing process was performed. FIG. 1B is a view illustrating the crystal structure. Reference numeral 10R denotes a p-type semiconductor portion and reference numeral 11R denotes an n-type semiconductor portion.

In addition to a material obtained by adding Mn²⁺ to activated ZnS, for example, a material obtained by adding a rare-earth element, such as Tm³⁺, Eu²⁺, Sm³⁺, or Tb³⁺, to the activated ZnS or a material obtain by adding Eu²⁺ or Ce³⁺ in CaS or SrS may be used as the material of the light emitting portion 5 used in the electroluminescent device 1 according to the embodiment of the invention. In addition, preferably, thiogallate-based phosphors expressed in chemical formula of (Ca, Sr, Ba) (Al, Ca, In)₂Ga₂S₄ can also be used; however, the invention is not limited to thereto. These fluorescent materials described above can be made by using a known method. For example, an EB evaporation method, a sputtering method, an MBE method, an MOCVD method may be used. Satisfactory crystals can be obtained by using the methods described above. For example, ultrafine particles can be obtained by the use of a mechanical method, such as grinding, so as to be used in the embodiment. In addition, the crystallinity can be improved by maintaining a substrate at a temperature of 200° C. or more when forming a thin film. Moreover, it is preferable to perform an annealing process after forming the thin film from the view point of improvement of luminous efficiency.

The film thickness of the light emitting portion 5 is preferably within a range of 0.1 μm to 10 μm. In the case when a hinder 12 or the like is used, the thin light emitting portion 5 is advantageous in reducing a driving voltage of the electroluminescent device 1. However, the film thickness is smaller than 0.1 μm, the light emitting portion 5 may he damaged, which may cause a problem such as leak between the anode 3 and the cathode 7.

On the light emitting portion 5 obtained as described above, the charge injection portion 6 was provided by using the same process as that used for the charge injection portion 4 described above.

Thereafter, aluminum was vapor-deposited in a thickness of 150 nm under the vacuum state, thereby forming the cathode 7.

As a material of the cathode 7, it is preferable to use a material which allows electrons to be injected into light emitting portion 5 or the charge injection portion 6 provided between the light emitting portion 5 and the cathode 7. In order to satisfy the condition, the relationship between an energy level of a material used for charge injection portion 6 and a work function of a material used for the cathode 7 is important. Therefore, a cathode material which allows electrons to be efficiently injected is selected in consideration of the relationship. A preferable material of the cathode 7 includes Al, Ag, and Au and also includes an alkaline earth metal and an alkali metal whose work function is low, For example, Mg, Ca, Li, Cs, or Ba may be used. In addition, fluoride, oxide, or carbonate known as a material of an organic electroluminescent device is preferably used, for example.

Further, since the cathode 7 used in the electroluminescent device 1 according to the embodiment of the invention preferably has an electron injection property, the cathode 7 having a work function smaller than or close to an electron injection level of the light emitting portion 5 or the charge injection portion 6 is more preferably used. Specifically, even though Al or Ag may be used, it is preferable to use an alkali metal whose work function is small, such as Ca, Ba, Li, or Cs in accordance with a luminescent material. In addition, oxides or fluorides of these metals are effective to improve the electron injection property. In this case, the film thickness is preferably 50 Å (5 nm) or less.

Furthermore, the cathode 7 may have a multi-layered structure where the above-described materials are used. For example, the cathode 7 may be configured such that an uppermost layer is formed using Ag and a layer (that is, layer closer to the light emitting portion 5 or the charge injection portion 6) positioned below the uppermost layer is formed using Ba.

The cathode 7 was vapor-deposited by using a mask such that an angle between the cathode 7 and the anode 3 formed of an ITO film is 90°. Thus, the electroluminescent device 1 (data S101) having a size of 2 mm squares was obtained in a portion where the cathode 7 overlaps the anode 3.

As will be described in a third embodiment, when the electroluminescent device 1 is typically used as a display apparatus, such as a display, or a minute light source, it is possible to partially cover the anode 3 (that is, periphery of the anode 3) in order to specify a luminous region (or area) by using a pixel regulating portion (not shown) which is substantially an insulator. An inorganic oxide, an inorganic nitride, a resist, or a compound thereof may be used as a material of the pixel regulating portion.

As described above, the electroluminescent device 1 according to the first embodiment of the invention includes a light emitting portion having at least a plurality of p-type semiconductor portions (crystal particles) and a plurality of n-type semiconductor portions (crystal particles), and emission centers are provided in at least a type of semiconductor portions of the p-type semiconductor portions and the n-type semiconductor portions.

Further, as described above, the electroluminescent device 1 according to the first embodiment of the invention includes electrodes opposite to each other with respect to the light emitting portion 5. The electrodes are composed of the pair of anode 3 and cathode 7, and at least the charge injection portion 6 is provided between the anode 3 and the light emitting portion 5.

The electroluminescent device 1 (sample S101) obtained as described above was moved to a glove box, a sealed glass (not shown) on which an ultraviolet curable resin is coated was bonded to the periphery of the glass substrate 2, and ultraviolet rays were irradiated to perform a sealing process. As described above, in order to prevent the electroluminescent device 1 from deteriorating due to moisture or oxygen from the outside, it is preferable to perform the sealing process for the electroluminescent device 1 according to the embodiment of the invention as necessary. Known sealing methods include an above-described method of bonding a sealant, such as a glass, by the use of adhesive, a method of performing the bonding process by the use of a resin, a method of performing the bonding process by the use of an inorganic film, and a method of performing the bonding process by the use of a laminated film having an inorganic film and an organic film, and these methods can be selectively used according to requirements. Moreover, it is also desirable to make a drying agent or the like included.

As described above, in the first embodiment, the sealing process has been performed by the use of a photosetting resin. Further, since heat resistance of the electroluminescent device 1 is noticeably improved by using an inorganic material on a light emitting layer, the sealing property can be further improved by performing the sealing process by the use of a thermosetting resin having an excellent gas barrier characteristic.

Thereafter, the electroluminescent device 1 was taken out of the glove box, and then a DC current was applied to the electroluminescent device 1 with an ITO film (anode 3) as a positive pole and an Al film (cathode 7) as a negative pole. Under the condition in which an applied voltage was set to about 3 V, an orange-colored luminescence considered as luminescence from ZnS:Mn (emission center) forming n-type semiconductor particles 11 was observed. The observation was made by the use of a microscope, and uniform planar luminescence was observed. The luminance was about 100 cd/m². In addition, as the voltage increase, the luminance also increases, and as a result, the maximum luminance of 100 cd/m² was obtained.

Next, the electroluminescent device 1 equal to the sample S101 except that the charge injection portion 6 in FIGS. 1A and 1B was removed was manufactured, which was set as a sample S102. As a result of evaluation of a characteristic of the sample 102, a voltage at the start of luminescence rose because charge injection effects due to the charge injection portion 6 can be reduced. But, the orange-colored luminescence was sufficiently observed. Furthermore, a characteristic of a sample 103, which was manufactured in the same manner as described above except that the charge injection portion 4 and the charge injection portion 6 were removed, was evaluated. As a result, the voltage at the start of luminescence rose more than before but the luminescence was sufficiently observed.

A voltage was adjusted such that the luminance of each of the samples becomes 10000 cd/n² and the samples were driven by predetermined current driving for 100 hours so as to observe the variation of luminance. As a result, luminance of 9200 cd/m² was obtained in the sample 101, luminance of 8600 cd/m² was obtained in the sample 102, and luminance of 7000 cd/m² was obtained in the sample 103. As can be seen from the result, in the electroluminescent device 1 according to the embodiment of the invention, reduced amounts of emitted light are different according to whether or not the charge injection portion 4 or (and) the charge injection portion 6 exists. However, all of the electroluminescent devices 1 showed very satisfactory driving stability in terms of high-luminance emission. This is an excellent property which is not obtainable in a planar light emitting element, such as an electroluminescent device in the related art.

Furthermore, samples were manufactured in the same manner as the samples S101 to S103 except that the film thickness of the light emitting portion 5 was adjusted to 50 nm. Then, the same evaluation as above was made. As a result, even though mere luminous non-uniformity was observed, high-luminance orange emission was obtained.

In the electroluminescent device according to the embodiment of the invention, it was possible to obtain the orange-colored luminescence (peak wavelength of 620 nm) considered to be based on the transition of Mn²⁺. This is considered to be luminescence at the time of returning to a base state (4T1 so 6Alg) from triplet in a first excited state of Mn²⁺.

Further, in the electroluminescent device according to the embodiment of the invention, when a bias voltage is applied, holes and electrons are injected from an anode and a cathode to ZnS, respectively. Pairs of holes and electrons formed on the ZnS, which are n-type semiconductor portions, are trapped in emission centers formed of n²⁺. In this case, when Mn²⁺ was in an excitation state, the orange-colored luminescence was observed.

Furthermore, as described above, in the electroluminescent device according to the embodiment of the invention, light is emitted in such a manner that the holes from the anode and the electrons from the cathode are injected into the light emitting layer and the holes and electrons are recombined with each other after a variety of excitation states.

As described above, according to the embodiment of the invention, holes could be easily injected because an oxide layer having a high work function is provided between the anode formed of ITO and the light emitting layer. This has not been possible in the related art. In addition, electrons could also be injected with a low voltage. This is because MoO₃ serving as a thin film of transition metal oxide used in the embodiment has an amorphous structure as a main structure and has many dangling bonds due to various crystal defects.

In addition, the light emitting portion according to the embodiment of the invention may be formed directly on a substrate by the use of a sputtering method or formed by using a method in which nanoparticles are combined in a colloidal solution and are then coated on a substrate, as well as the evaporation method.

Also, as well as a case in which p-type semiconductor portions and n-type semiconductor portions are in contact with each other in the same layer, a case in which a plurality of p-type semiconductor portions and a plurality of n-type semiconductor portions are repeatedly laminated in the form of layers is effective. In this case, pn junctions are formed on interfaces between the layers. For example, a configuration in which p-type semiconductor layers and n-type semiconductor layers are laminated in series by the sputtering method, and a configuration in which which ultra-thin films of p-type semiconductor layers and ultra-thin films of n-type semiconductor portions are repeatedly and alternately laminated by such as CVD method, are also effective. In this case, emmittion centers may be implanted after film formation.

### Second Embodiment

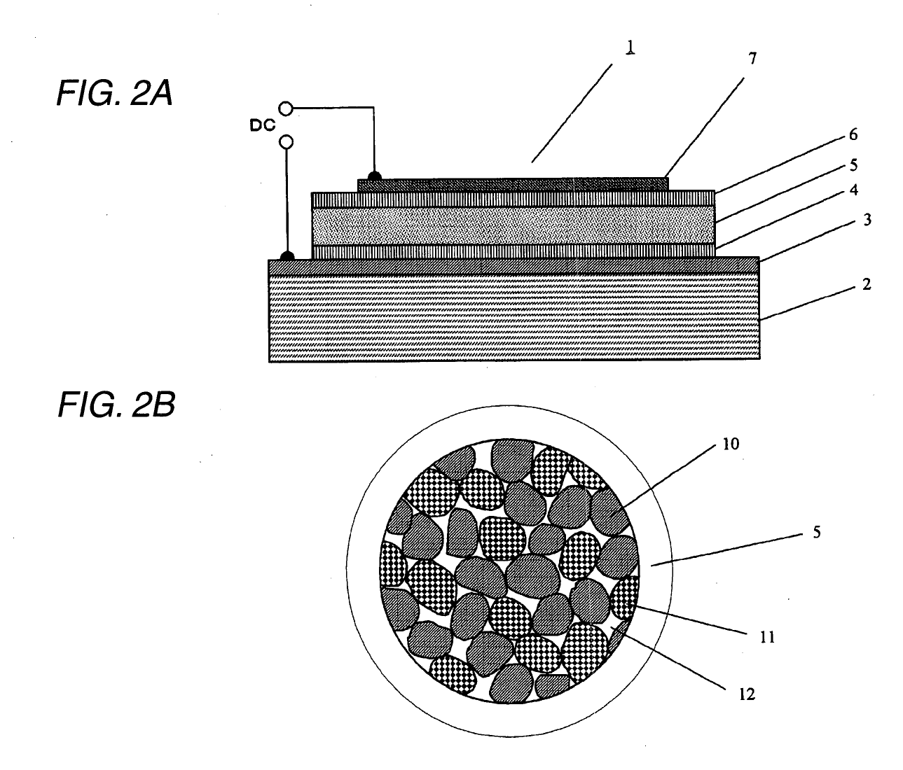

FIG. 2A is a cross-sectional view illustrating the structure of an electroluminescent device 1 according to a second embodiment of the invention, and FIG. 2B is an enlarged cross-sectional view illustrating the structure of a light emitting portion 5 of the electroluminescent device 1 according to the second embodiment of the invention.

As will be described in detail below, the electroluminescent device 1 according to the second embodiment of the invention includes the light emitting portion 5 having p-type semiconductor particles 10 and n-type semiconductor particles 11, and emission centers are provided in at least a type of semiconductor particles of the p-type semiconductor particles 10 and the n-type semiconductor particles 11.

In the second embodiment, ZnS:Mn crystal particles (n-type semiconductor particles 11) and GaAs crystal particles (p-type semiconductor particles 10) used for the light emitting portion 5 of each of the sample S101 to S103 were ground in a mechanical way so as to be about 0.05 μm in mean particle diameter. These crystal particles were mixed so as to be p-n type light emitting portion 80 part with respect to methyl methacrylate resin 20 part dissolved in an organic solvent (serving as the binder 12 used for coating) and were then coated by using a spin coating method, thereby forming the light emitting portion 5. Even though xylene was used as the organic solvent (binder 12) in the present embodiment, it is possible to use ketones, benzophenones, and aromatic hydrocarbons. In this case, after performing the spin coating, the formed light emitting portion 5 was put into a baking furnace at 200° C. for 30 minutes in order to sufficiently remove the solvent (binder 12). The film thickness of the light emitting portion 5 after the baking process was adjusted to 0.5 μm. Thus, by removing the solvent (binder) by means of the baking process, even in a case when a wet process such as a spin coating process is used, the configuration can be made such that the semiconductor particles forming the light emitting portion 5 are in contact with each other as shown in FIG. 1B.

Samples S201 to S203 were manufactured in the same manner as the samples S101 to S103 except that the light emitting portion 5 was configured as described above. An evaluation on the samples S201 to S203 made in the same manner as the samples S101 to S103 showed an excellent luminous characteristic even though reduced amounts of emitted light slightly increased.

As can be seen from the result described above, all of the samples to which a bulk hetero pn junction was effectively applied in the embodiment of the invention apparently showed a long operating life and high luminance in planar luminescence. In particular, effects when the charge injection portion 4 and the charge injection portion 6 according to the embodiment of the invention are used are noticeable.

In addition, the semiconductor particles made of ZrS:Mn and GaAs can be formed as so-called nanoparticles.

(Manufacturing of Nanoparticles)

Next, a method of manufacturing nanoparticles of ZnS:Mn²⁺ will be described.

Zinc chloride and manganese chloride are weighed in the mol ratio of 10:1 and are then put into a flask, and thus slurry is obtained by the use of chloroform. Then, superfluous tributylphosphine is added and boiled at 130° C. so as to dissolve the slurry. Thereafter, bistrimethyl sulfide corresponding to ½ mol of zinc chloride is added. A solution obtained above is agitated a day and is then boiled, thereby obtaining colorless nanoparticles formed of Zns:Mn. Then, the solution is condensed, washed by the use of heptane, and passes through a filter having a size of 100 nm so as to extract desired compound. This method is disclosed in Leeb et al., ‘J. Phys. Chem. B. Vol.103., p7839 (1999)’. The sizes of these particles are considered to be about several nanometers in a first particle diameter and about 10 to 20 nm in a second particle diameter. By using a spin coating method using the nanoparticles obtained as described above, the electroluminescent device 1 was manufactured by making an adjustment such that the thickness of the light emitting portion 5 was 0.1 μm. The diameters of the nanoparticles were 3 mm in estimation of a light-scattering type particle diameter measuring apparatus. Moreover, the samples S301 to S303 were manufactured in the same mixing ratio of the nanoparticles to a solvent as that in the samples S201 S203.

These samples were evaluated in the same manner as the samples S101 S103. A result of the evaluation showed high luminous efficiency and a long operating life even though current and luminance characteristics of light emission were reduced to about 70%.

Although the driving was performed by continuously applying a DC voltage, the same result was obtained when pulse driving was performed. In the case of the pulse driving, in addition to a forward bias, a reverse bias was applied in the same voltage. As a result, the luminance was reduced to about ½. As described above, the electroluminescent device 1 according to the embodiment of the invention showed satisfactory luminescence in both the continuous DC driving and the pulse driving. In the case of the pulse driving, application of the reverse bias is effective to extract charges stored in the element. In this case, it was observed that a driving life tended to extend.

As already described above, in the first embodiment or the second embodiment, the p-type semiconductor particles 10 and the n-type semiconductor particles 11 were configured to have diameters of (crystal particles in the first embodiment) 1.0 μm or less. Further, since an applied voltage required for the driving increases if the thickness of the light emitting portion 5 is too large, the thickness of the light emitting portion 5 is preferably 10 μm or less in consideration of a substantial driving condition (for example, about maximum 18 V) using a thin film transistor or the like.

Even though GaAs was used as a material of the p-type semiconductor particles 10 in the first embodiment or the second embodiment, GaAs is only an example. For example, III-V group compound doped with acceptors may be used as the material of the p-type semiconductor particles 10. Alternatively, AlSb, GaP, or InP may be used in addition to GaAs. On the other hand, ZnS was used as a material of the n-type semiconductor particles 11, ZnS is only an example. For example, III-V group compound doped with donors may be used as the material of the n-type semiconductor particles 11. Alternatively, a material based on CaS and SrS may be properly selected in addition to ZnS. In addition, as for both the p-type semiconductor particles 10 and the n-type semiconductor particles 11, impurities that form donors may be added when adding activation elements used to form the emission center.

Furthermore, even though MoO₃ was used as the charge injection portion 4 or the charge injection portion 6 in the first embodiment or the second embodiment, MoO₃ is only an example. That is, MoOₓ having a different oxidation number, for example, MoO₂ may be used. In addition, it is possible to use a material obtained by intentionally adjusting the oxidation number by an oxidation process or reduction process. Alternatively, as described above, other transition metal oxides may be used. It does not mean that only the transition metal oxides can be used as materials of the charge injection portion 4 or the charge injection portion 6. That is, taking functions of the charge injection portion 4 and the charge injection portion 6 into consideration, even if the charge injection portion is formed of, for example, a semiconductor, the same effect as that described in the first embodiment or the second embodiment can be obtained.

### Third Embodiment

Hereinafter, it will be described in detail about an example in which the electroluminescent device 1 having high luminance described in detail in the second embodiment is applied.

In the third embodiment, a plurality of electroluminescent devices 1 described in detail in the second embodiment are disposed in a two-dimensional manner so as to form a display apparatus.

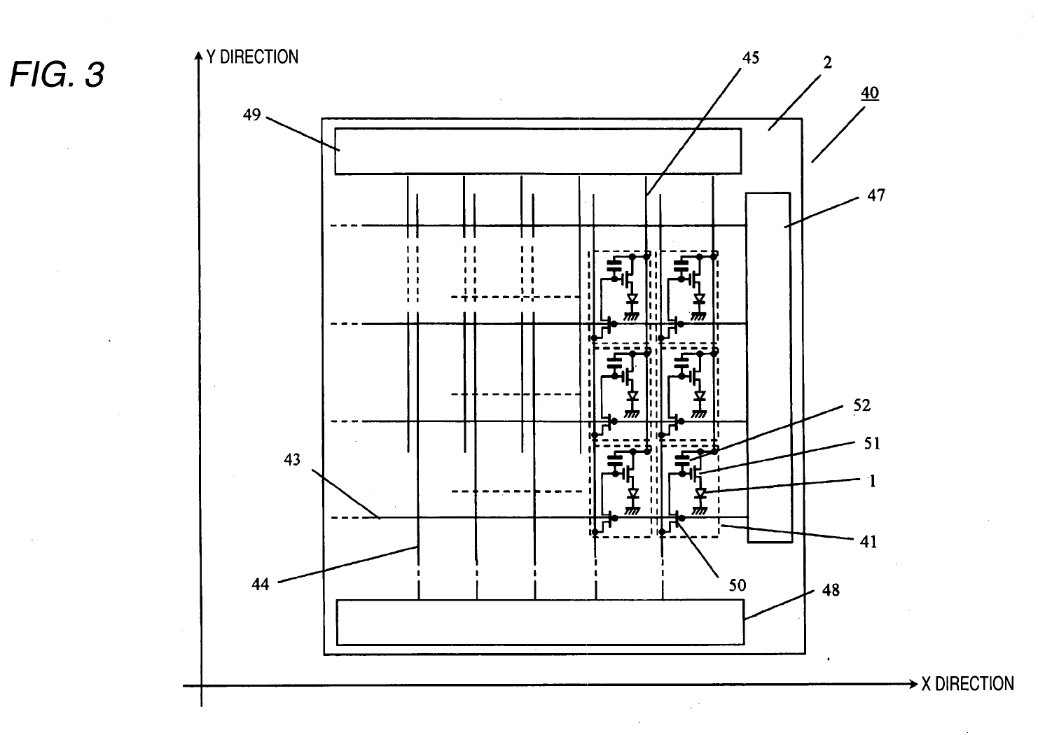

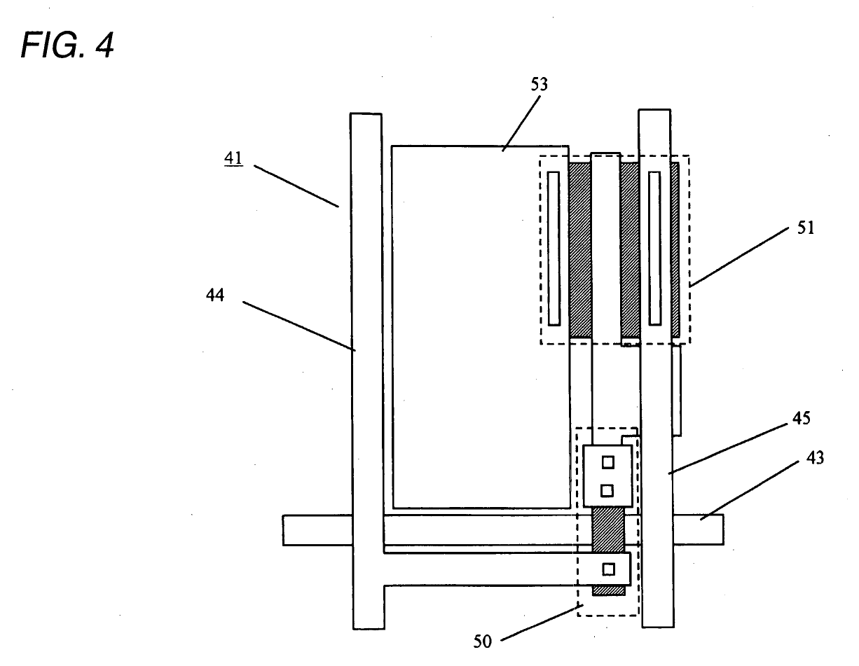

FIG. 3 is a block diagram illustrating the entire configuration of a display apparatus 40 according to the third embodiment of the invention. In FIG. 3, a basic circuit configuration of a driving circuit provided in each display pixel 41 is shown. In addition, FIG. 4 is a plan view illustrating the display pixel 41 included in the display apparatus 40 according to the third embodiment of the invention.

As shown in FIG. 3, the display apparatus 40 includes: a glass substrate 2 on which thin film transistors are formed in an array; a plurality of scanning lines 43 extending in an X direction and arranged at predetermined pitches in the Y direction; a plurality of signal lines 44 and a plurality of common power supply lines 45 extending in a Y direction and arranged at predetermined pitches in the X direction; a scanning line driver 47 that supplies scanning signals to the scanning lines 43; a signal line driver 48 that supplies data signals to the signal lines 44; a common power supply line driver 49 that supplies positive power (or negative power) having a predetermined electric potential to the common power supply lines 45, the scanning lines 43, the signal lines 44, the common power supply lines 45, the scanning line driver 47, the signal line driver 48, and the common power supply line driver 49 being formed on the glass substrate 2. Moreover, a display region is provided in a central portion of the glass substrate 2, and the plurality of display pixels 41 are disposed in the display region.

Subsequently, an explanation will be continued with reference to FIGS. 3 and 4.

As shown in FIGS. 3 and 4, each of the display pixels 41 is provided with a pixel circuit including a TFT (thin film transistor; hereinafter, referred to as a ‘switching TFT’) 50 that is formed of a thin film transistor and performs a switching operation, a TFT (hereinafter, referred to as a ‘current TFT’) 51 that is controlled by the switching TFT 50 and controls a current used to drive the display pixel 41, the electroluminescent device 1 according to the embodiment of the invention described above, and a storage capacitor 52. In addition, a drain of the current TFT 51 is connected to a pixel electrode 53 serving as an anode made of ITO (indium tin oxide) which is a transparent conductive material.

In the third embodiment, a pixel regulating portion (not shown) made of, for example, SiO or SiN is provided in the vicinity of the pixel electrode 53, such that a light emitting area of a light emitting portion (not shown; more specifically, including peripheral structure of the light emitting portion 5, the charge injection portion 4, and the charge injection portion 6 described in the first embodiment) formed on the pixel electrode 53 is substantially regulated by the pixel regulating portion. Alternatively, the light emitting area may be regulated by using the shape of the pixel electrode 53. In general, in the case of using the electroluminescent device 1 as a display apparatus, such as a display, or a minute light source, it is preferable to use a substantial insulator for the pixel regulating portion in order to regulate the light emitting area. An inorganic oxide, an inorganic nitride, a resist, or a compound thereof, which were described in the above embodiments, may be used as a material of the pixel regulating portion.

On a part of the light emitting portion opposite to the pixel electrode 53, a counter electrode (not shown) serving as a cathode, which is a laminated layer using a thin film of calcium or barium and a thin film of aluminum, is disposed. However, the counter electrode may be formed of a single layer using Ag (silver). As described above, the counter electrode is formed of at least a single-layered metal material, is formed over the entire surface of the glass substrate 2, and is grounded through a predetermined part.

The display apparatus according to the third embodiment described above includes electrodes (the pixel electrode 53 and the counter electrode (not shown)) opposite to each other with a light emitting portion interposed therebetween and a driving part that drives at least one (the pixel electrode 53) of the electrodes, and the driving part is formed by using a thin film transistor (the switching TFT 50 and the current TFT 51).

The lighting control of each of the display pixels 41 configured as above is performed as follows. When a scanning signal is output from the scanning line driver 47 to the scanning line 43 and a data signal is supplied from the signal line driver 48 to the signal line 44, the switching TFT 50 in the display pixel 41 corresponding to the scanning line 43 and the signal line 44 is turned on and a voltage of the data signal supplied to the signal line 44 is applied to a gate of the current TFT 51. At this time, a driving current corresponding to a gate voltage flows between drain and source of the current TFT 51 from the common power supply line driver 49 through the common power supply lines 45 and also flows from the electroluminescent device 1 to the counter electrode through the pixel electrode 53, and accordingly, the electroluminescent device 1 emits light. In addition, charges stored in the storage capacitor 52 while the switching TFT 50 is turned on are discharged after the switching TFT 50 is turned off, and thus a driving current of the electroluminescent device 1 flows over a period of time even after the switching TFT 50 is turned off. That is, in the display apparatus according to the third embodiment, the electrodes opposite to each other with the light emitting portion interposed therebetween are provided, the electrodes are formed as a pair of anode (the pixel electrode 53) and cathode (counter electrode (not shown)), and the display apparatus is driven by applying a DC voltage between the anode and the cathode.

Thereafter, the explanation will be continued by referring back to FIG. 2.

As described in the second embodiment, the electroluminescent device 1 according to the embodiment of the invention includes a light emitting portion having at least p-type semiconductor particles and n-type semiconductor particles, emission centers are provided in at least a type of semiconductor particles of the p-type semiconductor particles and n-type semiconductor particles, and an inorganic material with little deterioration is used for the electroluminescent device 1 as described above. Therefore, the display apparatus 40 using the electroluminescent device 1 has little reduction in an amount of emitted light and is very stable and reliable over a long period of time. Furthermore, since the electroluminescent device 1 described in the second embodiment is extremely high in luminous efficiency, power required to driving the electroluminescent device 1 is extremely small. As a result, the consumed power of the display apparatus 40 can be suppressed to be low.

The light emitting portion 5 that forms the display pixel 41 in the display apparatus 40 is formed by mixing the p-type semiconductor particles 10 and the n-type semiconductor particles 11 with the predetermined binder 12, which were described in the second embodiment, by means of a wet process (specifically, an inkjet method). Basically, the binder 12 is needed for coating. For example, by coating a colloidal solution, in which the semi-conductor particles are dispersed, using a volatile solvent as a material of the binder 12 and then volatilizing and removing the binder 12 by means of heat treatment, the p-type semiconductor particles 10 and the n-type semiconductor particles 11 can be formed on the pixel electrode 53 (or the charge injection portion 4) under the state in which the p-type semiconductor particles 10 and the n-type semiconductor particles 11 are in contact with each other. In the case of using the wet process so as to form the light emitting portion 5, it is basically necessary to secure the dispersibility of semiconductor particles in the colloidal solution, and the diameters of the semiconductor particles are preferably 1.0 μm or less in order to perform satisfactory mixture. At this time, an additive may be added to improve the dispersibility of semiconductor particles in the colloidal solution. For example, the additive is made of an organic material, and it is preferable to remove the additive after coating and forming the light emitting portion 5 by the use of plasma treatment (oxygen radical) where a mixed gas of argon and oxygen is used, for example. Due to the plasma treatment, the semiconductor particles are reliably in contact with each other.

Further, in the case of the color display apparatus 40, it is necessary to form the light emitting portion 5, which performs red, green, and blue colored light emission, on the pixel electrode 53. As already described in detail in the second embodiment, the electroluminescent device 1 according to the present embodiment of the invention includes the light emitting portion 5 having the p-type semiconductor particles 10 and the n-type semiconductor particles 11, and the n-type semiconductor particles 11 are formed of a material having an emission center. Furthermore, desired emission centers may be preferably provided in at least a type of semiconductor particles of the p-type semiconductor particles 10 and the n-type semiconductor particles 11. That is, a desired luminescent color can be selected by adding an activation element (activator), such as Cu, and a predetermined emission center (for example, Mn) in any one of ZnS, ZnO, SrS, CaS, CdS, CaGa₂S₄, SrGa₂S₄, and BaAl₂S₄. An example in which some of the materials is selected to obtain predetermined luminescent colors will now be described.

In order to emit red-colored light, for example, EuF₃ powder, CeF₃ powder, and Cu₂S powder are added and mixed with CaS powder and then these mixed powders are subjected to heat treatment in the argon atmosphere at predetermined temperature and time, thereby obtaining the n-type semiconductor particles 11. It is preferable to form the light emitting portion 5 by using the obtained n-type semiconductor particles 11. In addition, CaS:Ce or ZnS:Tb may also he used as another red luminescent material.

Further, in order to emit green-colored light, for example, Cu₂S powder is added and mixed with CaS powder and then these mixed powders are subjected to heat treatment in the argon atmosphere at predetermined temperature and time, thereby obtaining the n-type semiconductor particles 11. It is preferable to form the light emitting portion 5 by using the obtained n-type semiconductor particles 11. Moreover, CaS:Ce or ZnS:Tb may also be used as another green luminescent material.

Furthermore, in order to emit blue-colored light, for example, Cu₂S powder is added and mixed with CaS powder and then these mixed powders are subjected to heat treatment in the argon atmosphere at predetermined temperature and time, thereby obtaining the n-type semiconductor particles 11. It is preferable to form the light emitting portion 5 by using the obtained n-type semiconductor particles 11. Moreover, CaS:Ce or ZnS:Tb may also be used as another blue luminescent material.

In any cases described above, the n-type semiconductor particles 11 forming the light emitting portion 5 can be obtained by generating an n-type semiconductor by doping suitable donors in III-V group compound, for example, GaAs, making the n-type semiconductor into minute particles by means of, for example, grinding, and then classifying the minute particles.

On the other hand, the n-type semiconductor particles 10 forming the light emitting portion 5 can be obtained by generating a p-type semiconductor by doping suitable acceptors in III-V group compound, for example, GaAs, making the p-type semiconductor into minute particles by means of, for example, grinding, and then classifying the minute particles. In this case, in addition to GaAs, AlSb, GaP, InP, or the like may be used as the III-V group compound.

A colloidal solution, in which the p-type semiconductor particles 10 and the n-type semiconductor particles 11 obtained as described above are contained, are coated on the display pixel 41 at a predetermined position so as to be separated into red, green, and blue colored light emitting portions 5, and thus the full-color display apparatus 40 can be obtained. Since the coating of the light emitting portion 5 needs to be separated in correspondence with the position of the display pixel 41, it is preferable to coat the light emitting portion 5 by using an inkjet method in which a solution to be coated and the coating position can be selectively controlled. Alternatively, the light emitting portion 5 may be coated by using a printing method using a screen, the printing method being able to coat a solution so as to be separated in the same manner as described above.

It is needless to say that the light emitting portion 5 of each electroluminescent device 1 of the display apparatus 40 described in the third embodiment can be formed of crystal particles having the p-type semiconductor portion and the n-type semiconductor portion described in the first embodiment.

### Fourth Embodiment

Hereinafter, it will be described in detail about an example in which the electroluminescent device 1 having high luminance described in detail in the second embodiment is applied.

In the fourth embodiment, the exposure apparatus is configured to include the plurality of electroluminescent devices 1 described in detail in the second embodiment that are disposed in a two-dimensional manner.

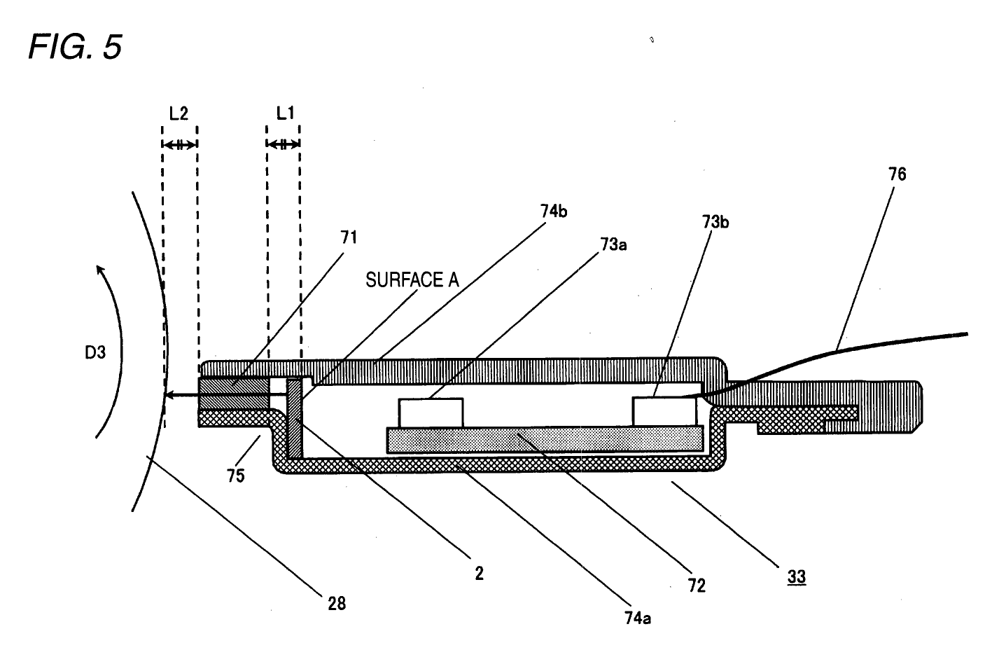

FIG. 5 is a view illustrating the configuration of an exposure apparatus according to the fourth embodiment of the invention. Now, the configuration of the exposure apparatus will be described in detail with reference to FIG. 5.

Referring to FIG. 5, reference numeral 33 denotes an exposure apparatus mounted on an image forming apparatus (not shown) using an electrophotographic method. The exposure apparatus 33 is a member that forms an electrostatic image on a surface of a photoconductor 28. A process of forming an electrostatic image on the photoconductor 28 and configuration and operation of the image forming apparatus will be described in detail later.

Reference number 2 denotes a glass substrate described above. The electroluminescent devices 1 serving as a light source for exposure are formed on a surface A of the glass substrate 2 in a resolution of 600 dpi (dot/inch) in a direction (main scanning direction) perpendicular to the plane of the drawing.

Reference numeral 71 denotes a lens array obtained by disposing rod lens (not shown) made of plastic or glass in rows. The lens array 71 makes an erect and unmagnified image, which is generated due to light emitted from the electroluminescent device 1 formed on the surface A of the glass substrate 2, imaged on the surface of the photoconductor 28 on which a latent image is formed. The positional relationship between the glass substrate 2, the lens array 71, and the photoconductor 28 is adjusted such that one focal point of the lens array 71 is the surface A of the glass substrate 2 and the other focal point of the glass substrate 2 is the surface of the photoconductor 28. That is, assuming that a distance from the surface A to a surface of the lens array 71 close to the surface A is L1 and a distance from the other surface of the lens array 71 to the surface of the photoconductor 28 is L2, the positional relationship is made to satisfy L1=L2. Due to the relationship, assuming that the thickness of the glass substrate 2 is Lg, the thickness Lg should set to satisfy Lg≦L1.

Reference numeral 72 denotes a relay substrate obtained by forming a circuit on a glass epoxy substrate by means of electrical components. Reference numeral 73a denotes a connector A and reference numeral 73b denotes a connector B. At least the connector A 73a and the connector B 73b are mounted on the relay substrate 72. The relay substrate 72 relays image data or light quantity correction data and other control signals, which are supplied from the outside to the exposure apparatus 33 through a cable 76 such as a flexible flat cable, through the connector B 73b, and these signals are transmitted to the glass substrate 2.

Taking into consideration a bonding strength or reliability in a variety of circumstances where the exposure apparatus 33 is placed, it is difficult to directly mount the connectors on the surface of the glass substrate 2. Accordingly, in the exposure apparatus 33 according to the fourth embodiment, an FPC (flexible printed circuit; not shown and will be described later) is used as a part for connecting the connector A 73a of the relay substrate 72 with the glass substrate 2 and, for example, an ACF (anisotropic conductive film) is used to bond the glass substrate 2 and the FPC with each other. Thus, the connectors are directly connected to, for example, ITO electrodes formed on the glass substrate 2 beforehand.

On the other hand, the connector B 73b is a connector used to connect the exposure apparatus 33 to the outside. In general, the connection using the ACF or the like causes a trouble in many cases. However, as described above, by preparing the connector B 73b that enables a user to connect the exposure apparatus 33, it is possible to secure sufficient strength with respect to an interface that a user directly access.

Reference numeral 74a denotes a housing A. For example, the housing A 74a is formed in a process of bending a metal plate. In the housing A 74a, an L-shaped portion 75 is formed opposite to the photoconductor 28, and the glass substrate 2 and the lens array 71 are disposed along the L-shaped portion 75. In the case in which the molding precision of the L-shaped portion 75 is secured by positioning a cross section of the housing A 74a facing the photoconductor 28 and a cross section of the lens array 71 on the same plane and making an end portion of the glass substrate 2 supported by the housing A 74a, it becomes possible to realize the positional relationship between the glass substrate 2 and the lens array 71 with high precision. As described above, since a highly precise dimension is required in the housing A 74a, it is preferable to form the housing A 74a with a metal. In addition, by forming the housing A 74a with the metal, it is possible to suppress an effect of noises with respect to electrical components, such as a control circuit formed on the glass substrate 2 and an IC chip mounted on the glass substrate 2.

Reference numeral 74b denotes a housing B obtained by molding a resin. A notch (not shown) is provided in the vicinity of the connector B 73b of the housing B 74b, and accordingly, a user can access the connector B 73b through the notch. Image data, light quantity correction data, control signals such as clock signals or line-synchronous signals, driving power of a control circuit, driving power of the electroluminescent device 1 serving as a light emitting element, and the like are supplied from the outside of the exposure apparatus 33 to the exposure apparatus 33 through the cable 76 connected to the connector B 73b.

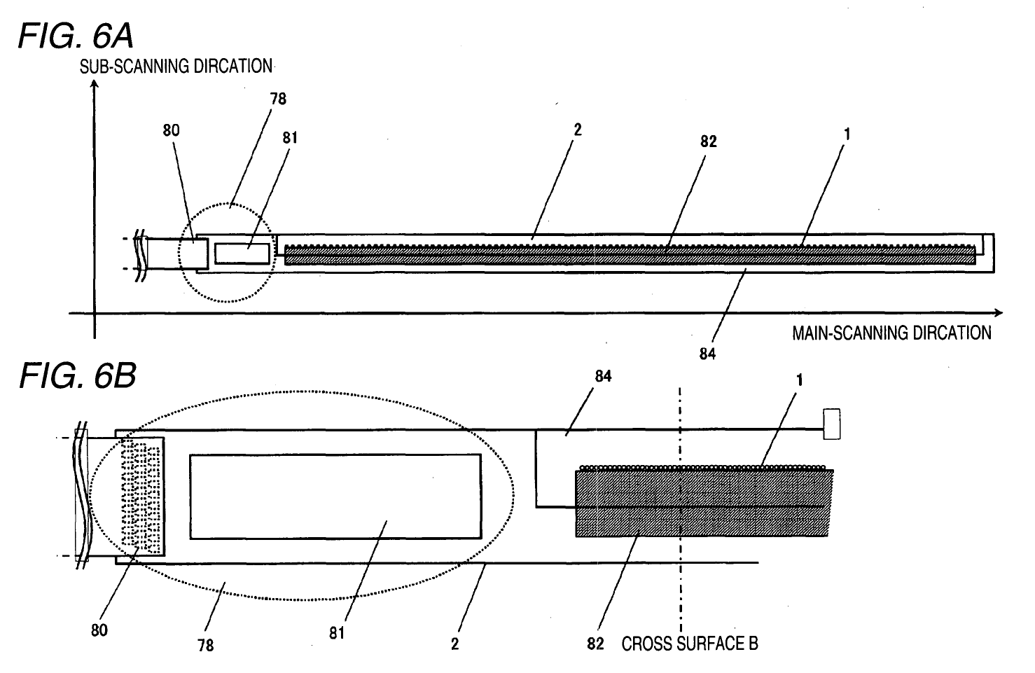

FIG. 6A is a top view illustrating the glass substrate 2 of the exposure apparatus 33 according to the fourth embodiment of the invention, and FIG. 6B is an enlarged view of the top view illustrating main parts of the glass substrate 2 of the exposure apparatus 33 according to the fourth embodiment of the invention. Hereinafter, the configuration of the glass substrate 2 in the fourth embodiment will be described in detail with reference to FIGS. 5 and 6.

Referring to FIGS. 6A and 6B, the glass substrate 2 is a rectangular substrate that is about 0.7 mm thick and has at least a long side and a short side, and a plurality of electroluminescent devices 1 are formed in rows in the longitudinal direction (main-scanning direction). In the fourth embodiment, the electroluminescent devices 1 required for at least A-4 sized (210 mm) exposure are disposed in the longitudinal direction of the glass substrate 2, and the length of the glass substrate 2 in the longitudinal direction is set to 250 mm including a space where a driving control part 78 to be described later is disposed. Moreover, in the fourth embodiment, the glass substrate 2 is set to have a rectangular shape for the convenience of explanation. However, the shape of the glass substrate 2 may be modified. For example, it is possible to provide a notch in a part of the glass substrate 2 for the purpose of positioning when placing the glass substrate 2 in the housing A 74a.

Reference numeral 78 denotes a driving control part that receives a control signal (signal for driving the electroluminescent device 1) supplied from the outside of the glass substrate 2 and controls the driving of the electroluminescent device 1 on the basis of the control signal. As will be described later, the driving control part 78 includes an interface part that receives the control signal from the outside of the glass substrate 2 and an IC chip (source driver 81) that controls the driving of the electroluminescent device 1 on the basis of the received control signal.

Reference numeral 80 denotes an FPC (flexible printed circuit) serving as an interface part that connects the connector A 73a of the relay substrate 72 and the glass substrate 2 with each other. The FPC 80 is directly connected to a circuit pattern (not shown) provided on the glass substrate 2 without a connector or the like therebetween.; As described above, the image data, the light quantity correction data, the control signals such as clock signals or line-synchronous signals, the driving power of the control circuit, and the driving power of the electroluminescent device 1, which are supplied from the outside to the exposure apparatus 33, are supplied to the relay substrate 72 and are then supplied to the glass substrate 2 through the FPC 80.

In the fourth embodiment, 5120 electroluminescent devices 1 serving as light sources of the exposure apparatus 33 are formed in rows in the main-scanning direction and in the resolution of 600 dpi, and each of the electroluminescent devices 1 is ON/OFF controlled independently by a corresponding TFT circuit 82. Reference numeral 81 denotes a source driver provided as an IC chip that controls the driving of the electroluminescent devices 1, and the source driver 81 is mounted on the glass substrate 2 in a flip chip mounting method. In consideration of surface mounting on a glass surface, a bare chip is used as the source driver 81. Power, control-related signals such as clock signals or line-synchronous signals, multi-value image data (for example, 6-bit gray-scale data), and light quantity correction data (for example, 8-bit multi-value data) are supplied from the outside of the exposure apparatus 33 to the source driver 61 through the FPC 80. The source driver 81 is also a driving parameter setting part for the electroluminescent device 1. More specifically, the source driver 81 sets a level of a driving current of each of the electroluminescent devices 1 on the basis of the multi-value image data and the light quantity correction data received through the FPC 80.

In the glass substrate 2, a connection part of the FPC 80 and the source driver 81 are connected to each other by means of a circuit pattern (not shown) made of ITO on which a meal is formed. The multi-value image data, the light quantity correction data, and the control signals such as clock signals or line-synchronous signals are input to the source driver 81, which serves as a driving parameter setting part, through the FPC 80. Thus, the FPC 80 serving as the interface part and the source driver 81 serving as the driving parameter setting part form the driving control part 78.

Reference numeral 82 denotes a TFT circuit formed on the glass substrate 2. The TFT circuit 82 includes a gate controller, such as a shift register and a data latch unit, which controls ON/OFF of the electroluminescent device 1, and a driving circuit (hereinafter, hereinafter referred to as a ‘pixel circuit’) that supplies a driving current to each of the electroluminescent devices 1. One pixel circuit is provided in each of the electroluminescent devices 1, and pixel circuits are disposed in parallel with rows of light emitting elements. A level of a driving current for driving each of the electroluminescent devices 1 is set in a pixel circuit by the source driver 81 which is a driving parameter setting part.

Power, control signals such as clock signals or line-synchronous signals, and multi-value image data (for example, the multi-value image data is 6-bit gray-scale data; however, a MSB (most significant bit) is actually used in the TFT circuit 82) are supplied from the outside of the exposure apparatus 33 to the TFT circuit 82 through the FPC 80. The TFT circuit 82 controls ON/OFF timing of each of the electroluminescent devices 1 on the basis of these power and signals.

Reference numeral 84 denotes a sealing glass for protecting the electroluminescent device 1 against an external atmosphere.

In the related art, in particular, in a case in which an electroluminescent device using an organic material for a light emitting portion is applied to the exposure apparatus 33, an amount of emitted light decreases as time goes by. Accordingly, it is necessary to dispose a predetermined light-receiving sensor on an end surface of the glass substrate 2 in order to measure an amount of emitted light of each electroluminescent device and then to control (that is, light quantity correction) the amount of emitted light of each electroluminescent device. However, since the light emitting portion of the electroluminescent device 1 according to the embodiment of the invention, which were described in detail in the second embodiment is configured to include p-type semiconductor particles and n-type semiconductor particles, that is, is formed of an inorganic material, deterioration observed in the case of an electroluminescent device formed of an organic material is not almost observed on a practical level Accordingly, since it is not necessary to perform light quantity measurement and light quantity correction based on a result of the measurement, it is possible to significantly reduce the hardware size of the exposure apparatus 33. As a result, the cost of the exposure apparatus 33 can be saved.

FIG. is an explanatory view illustrating a state in which the photoconductor 28 is exposed by the exposure apparatus 33 according to the fourth embodiment of the invention.

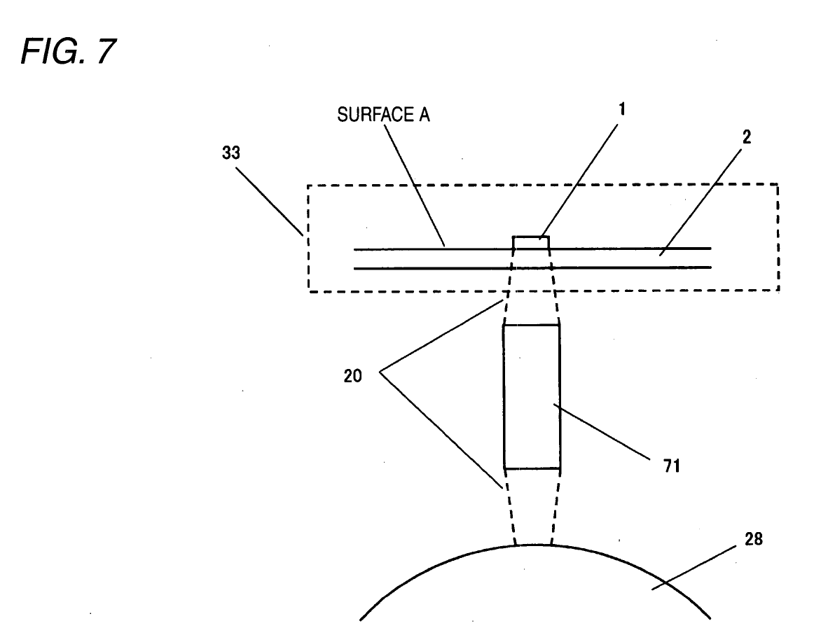

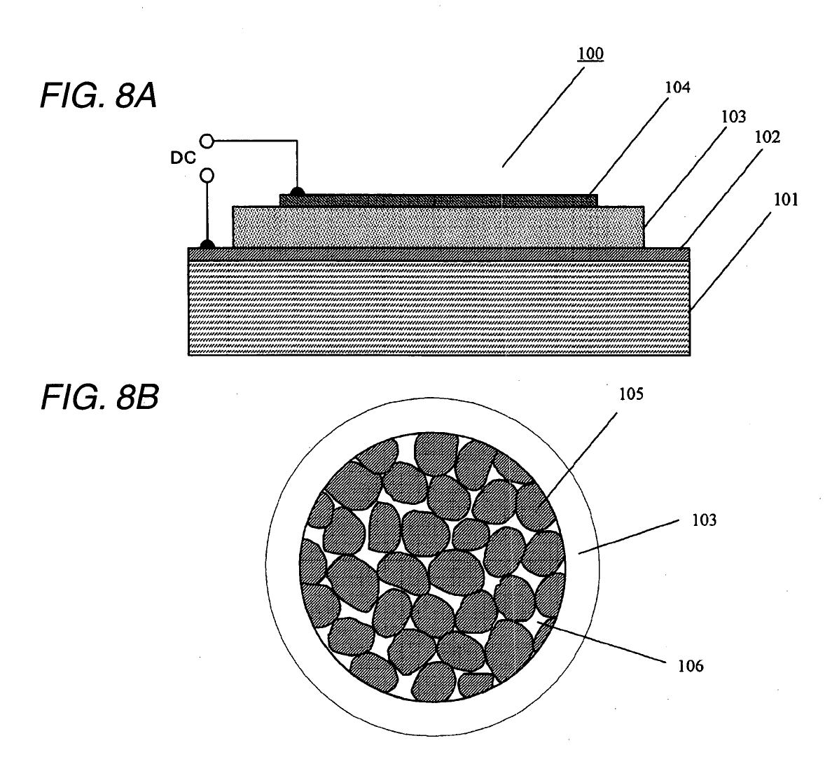

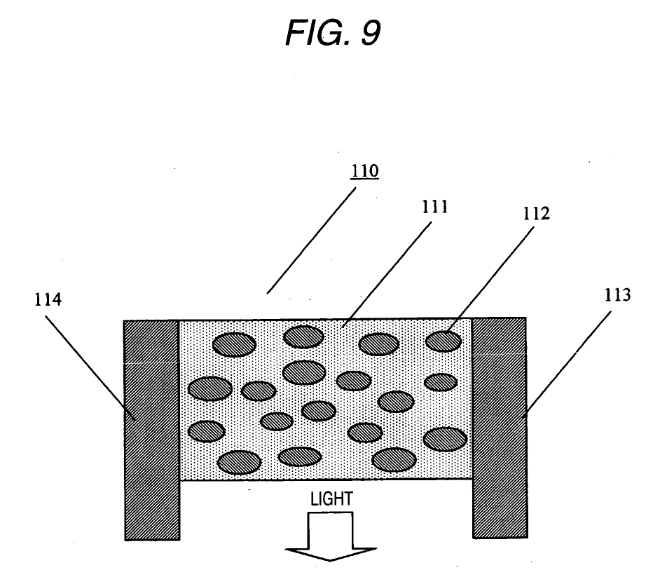

In FIG. 7, reference numeral 20 denotes a propagation path of light emitted from the electroluminescent device 1. The electroluminescent device 1 is formed on the surface A (refer to FIG. 5) of the glass substrate 2, and a lower surface of the glass substrate 2 is a light emitting surface.

Hereinafter, a process of forming a latent image using the exposure apparatus 33 according to the fourth embodiment will be described in detail with reference to FIG. 7.

Further, in FIG. 7, only parts required for explanation are shown for the convenience of explanation. Therefore, the explanation is made on the assumption that the glass substrate 2, the lens array 71, and the like are supported on the housing A 74a shown in FIG. 5 and the positional relationship between the photoconductor 28 and those described above is properly maintained.

Furthermore, in the fourth embodiment, the lens array 71 described above is used as an optical system that forms an erect and unmagnified image on the photoconductor 28. However, any kind of light guiding system may be used as long as it allows light emitted from the electroluminescent device 1 to be properly imaged on the photoconductor 28. For example, a microlens array or a planar optical system may be used. In addition, for example, by forming the electroluminescent device 1 on the glass substrate 2 having a thickness equal to or smaller than a maximum diameter (about 40 μm, since 600 dpi is assumed in the fourth embodiment) of the electroluminescent device 1, a so-called contact exposure system may be formed.

The electroluminescent device 1 shown in FIG. 7 is one of 5120 electroluminescent devices 1 disposed on the glass substrate 2 in a resolution of 600 dpi. In actual exposure, the plurality of electroluminescent devices 1 is collectively controlled as described above with reference to FIG. 6 and a two-dimensional latent image is formed on a surface of the photoconductor 28.

A process of forming a latent image on the photoconductor 28, transferring a developed toner image obtained by developing the latent image on paper, and performing heat fusing, a so-called electrophotographic process will be described in detail later. Here, it will be described about a process of forming light emitted from the electroluminescent device 1 on the photoconductor 28 so as to form a latent image, that is, electrostatic distribution and then adhering toner.

First, a surface of the photoconductor 28 is electrically charged by the use of a charger (not shown) such as a scorotron charger or a roller charger. Then, the light emitted from the electroluminescent device 1 propagates through the lens array 71 and is then imaged on the surface of the photoconductor 28. At this timer since the lens array 71 is an erecting and unmagnifying lens, the light emitted from the electroluminescent device 1 propagates through the propagation path 20 to be then imaged or the photoconductor 28 while maintaining luminous surface shape and luminous intensity distribution.

Only in a part of the photoconductor 28 to which light is irradiated, an electric potential becomes zero, and thus an invisible electrostatic image, that is, only a latent image is formed in the region. This is because the photoconductor 28 is made of a material having optical conductivity. When light is irradiated, the conductivity of only a part to which the light is irradiated increases. As a result, charges in a region where the light reaches are grounded to the earth through a conductive part formed on a bottom surface of the photoconductor 28. At this time, a level at which surface charges on the photoconductor 28 are grounded depends on the intensity of irradiated light for a predetermined period of time, and as intensive light strikes the surface, the surface potential becomes close to a ground potential. Thus, a latent image reflects the intensity distribution of irradiated light, that is, luminance intensity distribution of the electroluminescent device 1.

After forming the latent image, toner is adhered on the surface of the photoconductor 28 by the use of a developing unit (not shown). The toner is electrically charged beforehand at a predetermined potential and electrostatic interaction between the toner and a surface potential of the photoconductor 28 is performed by applying a predetermined bias potential to the developing unit (not shown). Thus, the toner is adhered on a portion where the latent image of the photoconductor 28 is formed in correspondence with Coulomb force based on the surface potential. At this time, adhesion of toner onto the photoconductor 28 depends on a state of the latent image, that is, the luminous intensity distribution of the electroluminescent device 1.

Eventually, the luminous intensity distribution of the electroluminescent device 1 which is a light source of the exposure apparatus 33 influences the adhesion condition of toner to the photoconductor 28, and this is completely reflected in a printing result.

As described above, the state of the latent image on the photoconductor 28 completely reflects a luminescence state of the electroluminescent device 1. Therefore, in order to maintain high-quality images, the luminescence state of the electroluminescent device 1 should be stable over a long period of time.

Thereafter, the explanation will be continued by referring back to FIG. 2.

The electroluminescent device 1 described in the second embodiment includes the light emitting portion 5 having at least the p-type semiconductor particles 10 and the n-type semiconductor particles 11, emission centers are provided in at least a type of semiconductor particles of the p-type semiconductor particles 10 and the n-type semiconductor particles 11, and an inorganic material with little deterioration is used for the electroluminescent device 1 as described above. Therefore, it is possible to realize a noticeably stable and reliable operation over a long period of time without reduction in an amount of emitted light. Furthermore, since the electroluminescent device 1 described in the second embodiment is extremely high in luminous efficiency, power required to driving the electroluminescent device 1 is extremely small. As a result, it is possible to reduce the power capacity of an image forming apparatus in which the exposure apparatus 33 is mounted. Thus, since the exposure apparatus 33 is formed by using the electroluminescent device 1 having the excellent performance as a light source, it is possible to provide a highly reliable exposure apparatus that can stably operate over a long period of time.

In the above description, an example in which the electroluminescent devices 1 are disposed in a one-dimensional manner is used as an example of the exposure apparatus 33. However, for example, it may be possible to adopt a so-called zigzagging pixel configuration in which the electroluminescent devices 1 are disposed in the main-scanning direction in a plurality of rows so as to alternate by a half pixel. With the configuration described above, the resolution at the time of forming an image can be substantially improved.

Since the sensitivity of the photoconductor 28 (specifically, an organic photoconductor (OPC)) where a latent image is formed by exposure is generally highest in red to near-infrared region (this is because a process of forming a latent image is performed using a laser beam having a peak wavelength in a near-infrared region, in a known image forming apparatus), the electroluminescent device 1 used in the exposure apparatus 33 preferably has a peak luminous wavelength in a wavelength region equal to or larger than at least 600 nm. From this point of view, it is preferable to select ZnS:TF3, SrS:Ce, K, Eu, or CaS:Eu as a material of the n-type semiconductor particles 11 used to form the light emitting portion 5.

Furthermore, in the case of the exposure apparatus 33, a luminescent color of all the electroluminescent devices 1 included in the exposure apparatus 33 is the same, and accordingly, it is not necessary to coat the light emitting portion 5 in a divisional manner unlike the case of the display apparatus described in the third embodiment. For this reason, in addition to an inkjet method or a printing method described in the third embodiment, it is possible to adopt a so-called manufacturing method in which the entire surface is coated, such as a spin coating method or a flood printing method.

It is needless to say that each of the electroluminescent devices 1 of the exposure apparatus 33 described in the fourth embodiment can be formed by using the p-type semiconductor particles (crystal particles) and the n-type semiconductor particles (crystal particles) described in the first embodiment.

### Fifth Embodiment

Hereinafter, it will be described in detail about an example in which the electroluminescent device 1 having high luminance described in detail in the second embodiment is applied.

In the fifth embodiment, a lighting apparatus is configured to include the single electroluminescent device 1 or the plurality of electroluminescent devices 1 described in detail in the second embodiment that are disposed in a one-dimensional or two-dimensional manner. First, an example of a lighting apparatus in which the single electroluminescent device 1 is used will be described by referring back to FIG. 2. When a DC voltage is applied to the electroluminescent device 1, light Generated in the light emitting portion 5 is emitted to the air through the glass substrate 2. By using the configuration after performing a sealing process, for example, it is possible to form a lighting apparatus serving as a portable lamp that is small and has high luminance. Since a luminescent color of a portable lamp is not specifically limited, a material of the n-type semiconductor particles 11 described in the first embodiment may be obtained by adding a predetermined activation element in any one of ZnS, ZnO, SrS, CaS, CdS, CaGa₂S₄, SrGa₂S₄, and BaAl₂S₄. Since the electroluminescent device 1 described in the first embodiment is extremely high in luminous efficiency, the power required to driving the electroluminescent device 1 is extremely small. As a result, the consumed power of the lighting apparatus can be suppressed to be low. For example, it is possible to provide an excellent portable lamp capable of perform high-luminance emission over a long period of time by the use of a few batteries.

Further, by setting the size of a luminous area of the electroluminescent device 1 to about 50 μm, for example, it is possible to simply obtain a light source whose power consumption is very low as compared with an LED. In this case, for example, a red-colored light source can be obtained by using ZnS:S, Cl as a material of the n-type semiconductor particles 11 described in the first embodiment, a green-colored light source can be obtained by using ZnS:Tb, F as the material of the n-type semiconductor particles 11, a yellow-colored light source can be obtained by using ZnS:Mn as the material of the n-type semiconductor particles 11, and a blue-colored light source can be obtained by using ZnS:Cu as the material of the n-type semiconductor particles 11. In addition, a combination of a plurality of single-colored light sources obtained as described above may be applied to an apparatus, such as traffic light. In addition, a lighting apparatus corresponding to a predetermined color can be simply formed by properly combining the red, green, and blue colored light sources. Since the electroluminescent device 1 is a device that performs planar luminescence, it is needless to say that an application such as the traffic light be formed by using the single electroluminescent device 1 having a large area.

Next, an example of a lighting apparatus in which the electroluminescent devices 1 are disposed in a one-dimensional manner will be described by referring back to FIG. 6. In the electroluminescent devices 1 disposed in the one-dimensional manner, for example, a configuration in which all of the electroluminescent devices 1 are turned on/off at the same time can be realized in a very easy way. For example, the lighting apparatus having the configuration described above may be used as a light source for document irradiation in an image reading apparatus called an image scanner (in this case, it is not necessary to use each of the electroluminescent devices 1 having minute sizes described in the fourth embodiment, but the electroluminescent devices 1 having a size of about several mm square may be disposed). Since a light source for document reading that uses the electroluminescent device 1 according to the embodiment of the invention can be formed to be extremely thin and narrow, the image reading apparatus can also be made thin. Moreover, in the case of using the lighting apparatus as the light source for document irradiation, it is preferable to select a luminescent material such that green-colored luminescence can be obtained in an image reading apparatus for monochrome image reading. On the other hand, in the case of an image reading apparatus for color image reading, it is preferable to sequentially dispose the electroluminescent devices 1, which emit red, green, and blue colored light as described in the third embodiment, in a one-dimensional manner such that a white color is displayed macroscopically.

Furthermore, since the glass substrate 2 on which the electroluminescent device 1 according to the embodiment of the invention is formed has an extremely fine width in the sub-scanning direction, the glass substrate 2 nay be easily applied to a side light source such as a backlight. In this case, it is not necessary to provide the electroluminescent device 1 on the glass substrate 2. For example, by forming the electroluminescent device 1 on a resin substrate made of PET or the like in consideration of workability, cost can be further saved.

In addition, as described above with reference to FIG. 6, the luminous pattern of the electroluminescent devices 1 disposed in a one-dimensional manner can be easily controlled by supplying predetermined data thereto. Accordingly, by moving a one-dimensional luminescence row configured as described above in the sub-scanning direction at a predetermined speed, the display can be made as if a character or a figure existed in the air due to an afterimage effect on a visual characteristic. Since the electroluminescent device 1 according to the embodiment of the invention has a high response speed like a typical organic electroluminescent device and has no afterglow, the electroluminescent device 1 can be applied to an apparatus corresponding to that described above.

Next, an example of a lighting apparatus in which the electroluminescent devices 1 are disposed in a two-dimensional manner will be described by referring back to FIG. 3. In the electroluminescent devices 2 disposed in the two-dimensional manner, for example, a configuration in which all of the electroluminescent devices 1 are turned on/off at the same time can be realized in a very easy way. In this case, even if the electroluminescent devices 1 are configured to be turned on/off at the same tine, it is preferable to make a configuration such that at least a type of electrodes (for example, anodes formed of ITO (refer to the pixel electrode 53 in FIG. 4)) are separated in the unit of the electroluminescent device 1. This is because, even if a defect occurs in the display pixel 41 due to a certain factor, the defect exists in the corresponding display pixel 41, and accordingly, a manufacturing yield of the entire lighting apparatus can be improved.

The lighting apparatus having the configuration described above may be applied to typical lighting equipment in a home, for example. In this case, since the lighting apparatus can be formed extremely thin, the lighting apparatus can be easily provided on a wall as well as a ceiling.

Furthermore, as described above with reference to FIG. 3, the luminous pattern of the electroluminescent devices 1 disposed in the two-dimensional manner can be easily controlled by supplying predetermined data thereto and a luminous area of the electroluminescent device 1 according to the embodiment of the invention can be set to a size of about 40 μm square, for example. Accordingly, it is possible to form an application that can also be used as a panel-type display apparatus by supplying data to a lighting apparatus. Even in this case, as described in the third embodiment, the display pixels 41 need to he coated with red, green, and blue colors in a divisional manner in correspondence with positions.

It is needless to say that each of the electroluminescent devices 1 of the lighting apparatus described in the fifth embodiment can be formed by using the p-type semiconductor particles (crystal particles) and the n-type semiconductor particles (crystal particles) described in the first embodiment.

When a known lighting apparatus is compared with a known display apparatus, luminance of the known lighting apparatus is higher than that of the known display apparatus. However, since the electroluminescent device 1 according to the embodiment of the invention has extremely high luminance, the electroluminescent device 1 can be used for both a lighting apparatus and a display apparatus. In this case, a mechanism for adjusting the luminance due to a functional difference (that, mode used) is needed in the lighting apparatus and the display apparatus. For example, the mechanism may be realized by adopting the configuration shown in FIG. 3 and controlling a driving current so as to adjust the luminance of each of the electroluminescent devices 1. That is, preferably, in the case when the electroluminescent devices 1 are used for the lighting apparatus, all of the electroluminescent devices 1 operate with a large amount of current, while in the case when the electroluminescent devices 1 are used for the display apparatus, each of the electroluminescent devices 1 is driven with a small amount current and a current level controlled corresponding to a gray-scale level (that is, in correspondence with image data). In such application, a single power supply may be used for both power when the application serves as the lighting apparatus and power when the application serves as the display apparatus. In addition, in the case when, for example, a dynamic range of a digital/analog converter for controlling a driving current is wide and the number of gray-scale levels when the application is used as the display apparatus is not sufficient, it is desirable to use a configuration in which a power supply (not shown) connected to the common power supply lines 45 shown in FIG. 4 switches according to a mode used. Even in a mode used as the lighting apparatus, in an application (that is, a lighting apparatus having a luminance control function) that requires luminance control, the adjustment can be easily made by the control of a current level corresponding to a gray-scale level, as described above. In addition, since the electroluminescent device 1 according to the embodiment of the invention can also be formed on a resin substrate made of PET or the like, without being limited to the glass substrate 2, the electroluminescent device 1 can also be applied as a variety of lighting apparatuses for illumination.

The electroluminescent device according to the embodiment of the invention has extremely high luminance and long life, and accordingly, the electroluminescent device may be applied as an alternative of a known light source to all kinds of products including lighting equipment, a traffic light, a backlight, and a lighting apparatus for an information apparatus. In addition, since the electroluminescent device according to the embodiment of the invention can he made extremely small, the electroluminescent device may be applied to an exposure apparatus mounted in a display apparatus such as a display, a copy machine, or an image forming apparatus such as a printer.

This application is based upon and claims the benefit of priority of Japanese Patent Application No 2005-369103 filed on May 12, 2200 and Japanese patent Application No. 2006-313120 filed on Jun. 11, 2000, the contents of which are incorporated herein by reference in its entirety.

What is claimed is:

1. An electroluminescent device, comprising:
a light emitting portion having at least p-type semiconductor particles and n-type semiconductor particles,
wherein emission centers are provided in at least a type of semiconductor particles of the p-type semiconductor particles and the n-type semiconductor particles.

2. The electroluminescent device according to claim 1, further comprising:
electrodes opposite to each other with the light emitting portion interposed therebetween,
wherein the electrodes include a pair of anode and cathode, and
at least a charge injection portion is provided between the anode and the light emitting portion.

3. The electroluminescent device according to claim 2,
wherein the anode is made of a substantially transparent conductive material.

4. The electroluminescent device according to claim 2,
wherein the cathode is made of at least a single-layered metal material.

5. The electroluminescent device according to claim 2,
wherein the charge injection portion is made of a transition metal oxide.

6. The electroluminescent device according to claim 5,
wherein the charge injection portion is made of any one of molybdenum oxide, vanadium oxide, and tungsten oxide.

7. The electroluminescent device according to claim 2,
wherein the charge injection portion is formed of a semiconductor.

8. The electroluminescent device according to claim 1, further comprising:
electrodes opposite to each other with the light emitting portion interposed therebetween,
wherein the electrodes include a pair of anode and cathode, and
a DC voltage is applied between the anode and the cathode so as to drive the anode and the cathode.

9. The electroluminescent device according to claim 1, further comprising:
electrodes opposite to each other with the light emitting portion interposed therebetween; and
a driving part that drives at least one of the electrodes,
wherein the driving part is formed by using a thin film transistor.

10. The electroluminescent device according to claim 1,
wherein the p-type semiconductor particles and the n-type semiconductor particles are in contact with each other in the light emitting portion.

11. The electroluminescent device according to claim 10,
wherein the light emitting portion includes at least the p-type semiconductor particles, the n-type semiconductor particles, and a binder, and
the light emitting portion is formed in a wet process.

12. The electroluminescent device according to claim 1,
wherein the diameter of each of the p-type semiconductor particles and the n-type semiconductor particles is 1.0 μm or less.

13. The electroluminescent device according to claim 1,
wherein the light emitting portion has a layered shape, and
the thickness of the layered light emitting portion is within a range of 0.1 μm to 10 μm.

14. The electroluminescent device according to claim 1,
wherein the p-type semiconductor particles are made of III-V group compound.

15. The electroluminescent device according to claim 1,
wherein the n-type semiconductor particles are made of a material having the emission center.

16. The electroluminescent device according to claim 15, further comprising:
wherein the material having the emission center is obtained by adding a predetermined activation element in any one of ZnS, ZnO, SrS, CaS, CdS, CaGa₂S₄, SrGa₂S₄, and BaAl₂S₄.

17. A display apparatus having the plurality of electroluminescent devices according to claim 1 disposed in a two-dimensional manner.

18. An exposure apparatus having the plurality of electroluminescent devices according to claim 1 disposed in a one-dimensional or two-dimensional manner.

19. A lighting apparatus having the single electroluminescent device or the plurality of electroluminescent devices according to claim 1 disposed in a one-dimensional or two-dimensional manner.

20. An electroluminescent device comprising:
a light emitting portion having at least a plurality of p-type semiconductor portions and a plurality of n-type semiconductor portions,
wherein emission centers are provided in at least a type of semiconductor portions of the p-type semiconductor portions and the n-type semiconductor portions.
